(19) United States
(12) Patent Application Publication
(10) Pub. No.: US 2026/0012716 A1
(43) Pub. Date: Jan. 8, 2026

(54) SOLID-STATE IMAGING DEVICE

(71) Applicant: Samsung Electronics Co., Ltd., Suwon-si (KR)

(72) Inventor: Yoshiharu Kudo, Yokohama (JP)

(73) Assignee: Samsung Electronics Co., Ltd., Suwon-si (KR)

(21) Appl. No.: 19/247,745

(22) Filed: Jun. 24, 2025

(30) Foreign Application Priority Data
Jul. 4, 2024 (JP) 2024-108047
Apr. 11, 2025 (KR) 10-2025-0047685

(51) Int. Cl. H04N 25/773; H04N 25/46; H04N 25/47

(52) U.S. Cl. CPC H04N 25/773; H04N 25/46; H04N 25/47

(57) ABSTRACT

Provided is a solid-state imaging device including various functions while preventing a decrease in spatial resolution of imaging. The solid-state imaging device includes a plurality of pixels respectively including single-photon avalanche diodes (SPADs) and multiple types of signal processing circuits performing different operations from each other. The multiple types of signal processing circuits are configured to receive a digital signal output from each of the SPADs.

### CROSS-REFERENCE TO RELATED APPLICATIONS

This application claims the benefit of Japanese Patent Application No. 2024-108047, filed on Jul. 4, 2024, in the Japanese Patent Office and Korean Patent Application No. 10-2025-0047685, filed on Apr. 11, 2025, in the Korean Intellectual Property Office, the disclosures of which are incorporated herein in their entireties by reference.

### BACKGROUND

The inventive concept relates to a solid-state imaging device.

Recently, solid-state imaging devices (or image sensors) using a single-photon avalanche diode (SPAD) as a photoelectric converter have been attracting growing attention.

Because a SPAD outputs a count corresponding to the number of photons received for a certain time period, the output of a photoelectric converter may be treated as a digital signal.

As a solid-state imaging device having this structure, for example, a solid-state imaging device disclosed in JP Publication No. 2020-96347 is known. The solid-state imaging device disclosed in JP Publication No. 2020-96347 is an asynchronous solid-state imaging device (e.g., a dynamic vision sensor (DVS)) and uses technology as described below. The solid-state imaging device includes a pixel array composed of a plurality of pixel blocks, each of which is composed of a plurality of pixels each including a SPAD. Each pixel block includes an address event detection pixel, which detects a temporal change in the amount of dynamically incident light, and a counting pixel, which counts the number of photons incident to a SPAD. When an event is detected by the address event detection pixel, the counting pixel of the pixel block counts incident photons and outputs a pixel signal indicating a count value.

However, in the solid-state imaging device disclosed in JP Publication No. 2020-96347, since an address event detection pixel is included in a pixel block in a position of a detecting pixel instead of the counting pixel, it is impossible to count photons in this position in the pixel block. Therefore, the spatial resolution of imaging is decreased.

### SUMMARY

The inventive concept provides a solid-state imaging device including various functions while preventing a decrease in spatial resolution of imaging.

According to an aspect of the inventive concept, there is provided a solid-state imaging device including a plurality of pixels respectively including single-photon avalanche diodes (SPADs) and at least two signal processing circuits performing different operations from each other, wherein the at least two signal processing circuits are configured to receive a digital signal output from each of the SPADs.

According to another aspect of the inventive concept, there is provided a pixel array including a plurality of photoelectric converters and a plurality of signal processing circuits. Each of the plurality of photoelectric converters includes a SPAD, and the plurality of signal processing circuits include a first signal processing circuit configured to receive a first digital signal output from a SPAD included in a first photoelectric converter among the plurality of photoelectric converters and a second signal processing circuit configured to also receive the first digital signal with the first signal processing circuit and perform a different operation than the first signal processing circuit.

According to a further aspect of the inventive concept, there is provided a solid-state imaging device including a pixel array including a plurality of pixels, a vertical scanning unit configured to select a pixel corresponding to a row based on a synchronous signal among the plurality of pixels and control the selected pixel to output a signal, a horizontal scanning unit configured to select a pixel corresponding to a column based on the synchronous signal among the plurality of pixels and control the selected pixel to output a signal, and a signal output unit configured to receive a signal from the pixel array and output image data. Each of the plurality of pixels includes a SPAD and at least two signal processing circuits configured to receive a digital signal output from the SPAD and perform different operations from each other.

### BRIEF DESCRIPTION OF THE DRAWINGS

Embodiments will be more clearly understood from the following detailed description taken in conjunction with the accompanying drawings in which:

FIG. 1 is a block diagram illustrating a configuration of a solid-state imaging device according to an embodiment;

FIG. 2 is a block diagram illustrating a configuration of a pixel according to an embodiment;

FIG. 3 is a block diagram illustrating multiple types of signal processing circuits respectively arranged in different wafers, according to an embodiment;

FIG. 4 is a block diagram illustrating a solid-state imaging device according to an embodiment;

FIG. 5 is a block diagram illustrating a solid-state imaging device according to an embodiment;

FIG. 6 is a block diagram illustrating a color correspondence relationship of a photoelectric converter connected to a moving image counting circuit, according to an embodiment;

FIG. 7 is a block diagram illustrating a correspondence relationship of a photoelectric converter connected to a moving image counting circuit, according to an embodiment;

FIG. 8A is a block diagram illustrating a solid-state imaging device according to an embodiment;

FIG. 8B is a block diagram illustrating a planar arrangement of FIG. 8A, according to an embodiment;

FIG. 9 is a block diagram illustrating a solid-state imaging device according to an embodiment;

FIG. 10 is a block diagram illustrating a solid-state imaging device according to an embodiment;

FIG. 11 is a block diagram illustrating a solid-state imaging device according to an embodiment;

FIG. 12 is a block diagram illustrating a solid-state imaging device according to an embodiment;

FIG. 13 is a block diagram illustrating a solid-state imaging device according to an embodiment;

FIG. 14 is a block diagram illustrating a solid-state imaging device according to an embodiment;

FIG. 15 is a block diagram illustrating the flow of data in a solid-state imaging device, according to an embodiment;

FIG. 16 is a graph illustrating the influence of a flicker;

FIG. 17 is a graph illustrating the influence of a flicker;

FIG. 18 is a graph illustrating a noise removing process according to an embodiment; and

FIG. 19 is a block diagram illustrating effects of an embodiment.

### DETAILED DESCRIPTION OF THE EMBODIMENTS

Hereinafter, embodiments are described in detail with reference to the accompanying drawings. However, the scope of the inventive concept is not limited to these embodiments. In the drawings, like reference characters or numerals denote like elements, and the size of each element is expressed in a different ratio from the actual size for clarity and convenience of description. The embodiments described below are just examples, and various modifications may be made therein.

The expression “on” or “on the top of” may include a case where one element is in contact with another element and a case where one element is arranged without being in contact with another element.

The singular forms are intended to include the plural forms as well, unless the context clearly indicates otherwise. When a portion “includes” or “has” an element, another element may be further included, rather than excluding the existence of the other element, unless otherwise described.

The use of the terms “a” and “an” and “the” and similar referents is to be construed to cover both the singular and the plural.

The use of any and all examples, or exemplary language (e.g., “such as”) provided herein is intended merely to better illuminate embodiments and does not pose a limitation on the scope of embodiments unless otherwise claimed.

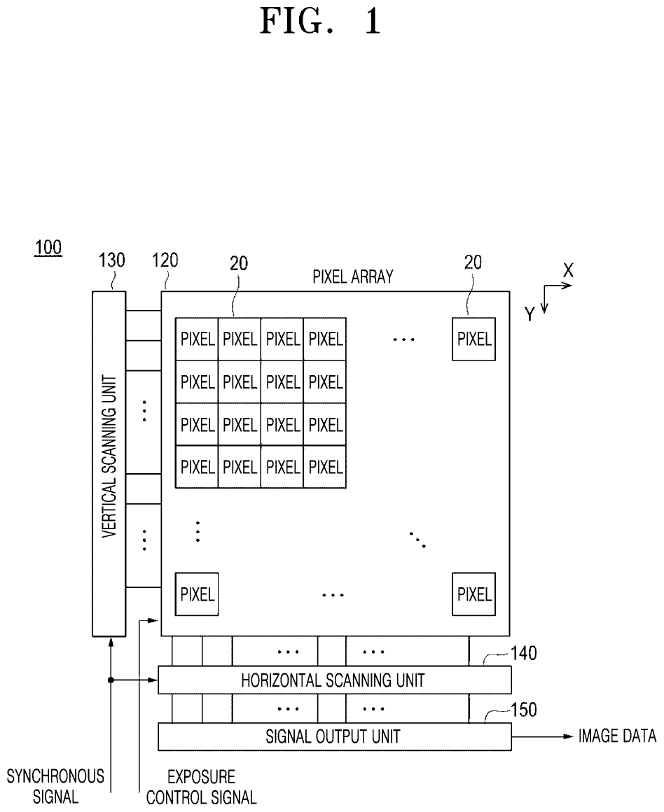

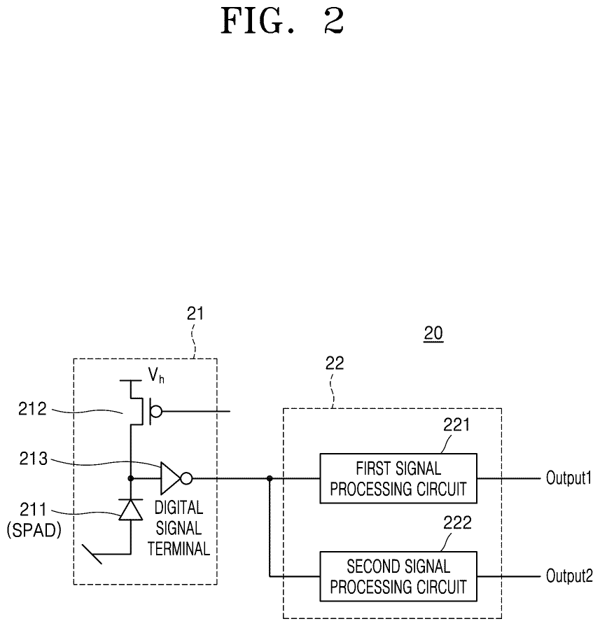

FIG. 1 is a block diagram illustrating a configuration of a solid-state imaging device 100 according to an embodiment. FIG. 2 is a block diagram illustrating a configuration of a pixel according to an embodiment. The configuration of a pixel in FIG. 1 is described with reference to FIG. 2.

Referring to FIG. 1, the solid-state imaging device 100 may include a pixel array 120, a vertical scanning unit 130, a horizontal scanning unit 140, and a signal output unit 150. The pixel array 120 may include a plurality of pixels 20 in an array side by side in a row direction (hereinafter, referred to as an X direction or a horizontal direction) and a column direction (hereinafter, referred to as a Y direction or a vertical direction). All (e.g., several millions or more) pixels 20 of the solid-state imaging device 100 may be included in the pixel array 120.

A synchronous signal may be input to each of the vertical scanning unit 130 and the horizontal scanning unit 140, and an exposure control signal may be input to the pixel array 120.

Rows Y may be sequentially selected by the vertical scanning unit 130 and columns X may be sequentially selected by the horizontal scanning unit 140 so that the pixels 20 may be sequentially selected in an XY address manner, and a pixel signal (or a count signal) of each selected pixel 20 may be output to the signal output unit 150 through a signal line. The signal output unit 150 may collect the pixels signals of the pixels 20 through signals lines and output image data to an external recording medium or a signal processor.

Referring to FIG. 2, each of the pixels 20 may include a photoelectric converter 21 and a signal processor 22. Each pixel 20 may include one photoelectric converter 21. Some elements of the signal processor 22 may be shared by multiple pixels 20.

The photoelectric converter 21 may include a single-photon avalanche diode (SPAD) (or referred to as a photoelectric conversion element) 211, a quench element 212, and a waveform shaping element 213. The photoelectric converter 21 may output a pulse signal according to the quantity of incident light. The photoelectric converter 21 may use, as a photodiode, the SPAD 211 that counts the number of photons incident to the entry surface of the photoelectric converter 21. Hereinafter, the photodiode is referred to as the SPAD 211. The SPAD 211 may refer to a next-generation semiconductor optical element having extremely high efficiency in detecting single photons due to the very high gain characteristic of the element. When a voltage higher than the breakdown voltage of an element is applied to the SPAD 211, free electrons may be accelerated by a very large electric field, causing strong collision with atoms, and accordingly, impact ionization, in which electrons bound to atoms are released and the number of free electrons rapidly increases, may occur. This is referred to as avalanche amplification, and this effect may greatly increase the number of free electrons generated by external photons incident to an image sensor.

The quench element 212 may be composed of a cathode resistance element of the SPAD 211 or a metal-oxide semiconductor (MOS) transistor. An example configuration of the MOS transistor may be described below. An end of the quench element 212 may be connected to the cathode of the SPAD 211, and a voltage Vh higher than a ground voltage applied to the anode of the SPAD 211 may be applied to an opposite end of the quench element 212. Whenever photocurrent is output from the SPAD 211 by the incident of a photon, the photocurrent may flow to the quench element 212 so that the cathode potential of the SPAD 211 may drop to a value lower than the voltage Vh.

The waveform shaping element 213 may include an inverter and have a pulse generation function by which an output of the SPAD 211 is converted into a pulse signal. When the voltage of the cathode of the SPAD 211 is decreased by photocurrent and an output signal (or referred to as an optical signal) input to the waveform shaping element 213 reaches an inversion threshold voltage, an output of the waveform shaping element 213 may be inverted so that a pulse signal may be output as logic high. Hereinafter, an output terminal of the waveform shaping element 213, which outputs a digital signal that is output from the SPAD 211 according to incident photons, may be referred to as a digital signal terminal. Being connected in parallel to the digital signal terminal connected to the SPAD 211 may be simply said as being connected in parallel to the SPAD 211.

The signal processor 22 may include multiple types of signal processing circuits (e.g., circuits (e.g., 225 to 229) described below), which are connected in parallel to the digital signal terminal and perform different operations from each other. Hereinafter, multiple types of signal processing circuits may be referred to as a plurality of signal processing circuits or at least two signal processing circuits. The connection between a digital signal terminal connected to the SPAD 211 and a plurality of signal processing circuit may be at least one selected from the group consisting of 1-to-n connection, n-to-1 connection, and n-to-n connection, where “n” is an integer of at least 2. In any cases, a plurality of signal processing circuits may be connected in parallel to the digital signal terminal connected to one SPAD 211.

In some embodiments, even though having the same circuit configuration as each other, multiple types of signal processing circuits performing different operations may be referred to as different types of signal processing circuits. For example, even through having the same configuration, signal processing circuits having different periods (i.e., frame rates) or timings of exposure reading may be referred to as different types of signal processing circuits.

The type of signal processing circuit may be selected by combining at least two of signal processing circuits described below. Some of these signal processing circuits are described with reference to the drawings below.

In some embodiments, a signal processing circuit may correspond to a counting circuit for still or moving images for image output. Specifically, a signal processing circuit may correspond to a counting circuit (or counter), which is connected to a digital signal terminal connected to one SPAD 211 and generates a still image. As a different type of counting circuit, a signal processing circuit may correspond to a counting circuit, which is connected to a digital signal terminal connected to one SPAD 211 and generates a moving image. Hereinafter, a counting circuit for still images may be referred to as a still image counting circuit, and a counting circuit for moving image may be referred to as a moving image counting circuit. The moving image counting circuit may have a different frame rate than the still image counting circuit. In the pixel array 120, the number of still image counting circuits may be different from the number of moving image counting circuits (for example, the number of moving image counting circuits may be less than the number of still image counting circuits), and the resolution of image data of the still image counting circuit may be different from that of the moving image counting circuit.

In some embodiments, a signal processing circuit may correspond to a multi-connection binning counting circuit which is connected to a digital signal terminal connected to a plurality of SPADs 211. This signal processing circuit may correspond to a binning counting circuit, which sums digital signals from multiple digital signal terminals, or a counting circuit, which switches a connection point (or a digital signal terminal that effectively counts). Hereinafter, a multi-connection counting circuit is referred to as a binning counting circuit. The binning counting circuit may count signals resulting from multiplexing by a parallel-to-serial conversion circuit (i.e., a multiplexer (MUX)). The binning counting circuit may generate a still image or a moving image, which has a sparser arrangement pitch than typical still or moving image signal processing circuit.

In some embodiments, as an event detection counting circuit, a signal processing circuit may correspond to a comparison circuit, which is connected to a digital signal terminal connected to one SPAD 211 and detects a temporal signal change. Hereinafter, a temporal signal change may be referred to as an event, and an event detection counting circuit is referred to as an event detection circuit (EDC). As described below, the EDC may include a counting circuit or a counter, which detects an event.

In some embodiments, as a binning event detection counting circuit, a signal processing circuit may correspond to a comparison circuit, which is connected to a digital signal terminal connected to a plurality of SPADs 211 and detects a temporal signal change (i.e., an event) in the sum of digital signals. This binning event detection counting circuit may be the same as the event detection counting circuit described above, except for a function of summing a plurality of digital signals. Hereinafter, the event detection counting circuit and the binning event detection counting circuit may be collectively referred to as a comparison circuit related to event detection or an event detection counting circuit. As described below, this circuit may include a counting circuit for detecting a binning event. This event detection counting circuit that counts signals resulting from multiplexing by a MUX may correspond to a circuit that detects an event and has a sparser arrangement pitch than a typical signal processing circuit for event detection.

In some embodiments, as a spatial step detection counting circuit, a signal processing circuit may correspond to a comparison circuit, which is connected to a digital signal terminal connected to a plurality of SPADs 211 respectively located at different positions and counts output differences between digital signals. This spatial step detection counting circuit may be used to detect a step or an edge based on a contrast difference between two SPADs 211.

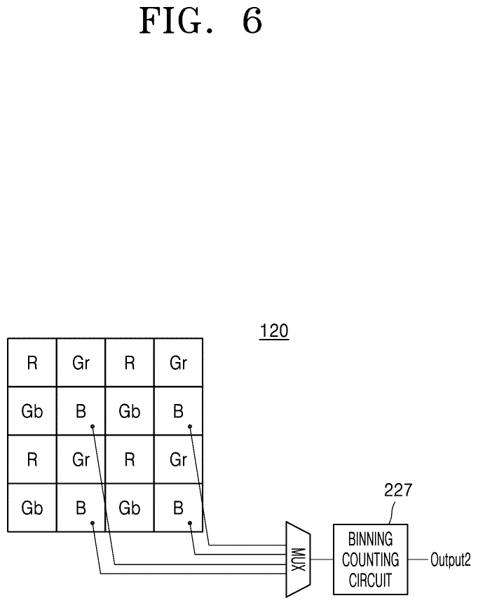

Hereinafter, the spatial step detection counting circuit may be referred to as an edge detection circuit or a step detection circuit (SDC). For example, in a bayer pattern, R, G, G, and B optical filters may be respectively arranged in adjacent four pixels 20 in a 2×2 array, and 2×2 sets may be repeated arranged in the horizontal and vertical directions. In this case, the spatial step detection counting circuit may be connected to respective digital terminals of two adjacent SPADs 211 of the same color (see FIG. 6 described below).

In the embodiment of FIG. 2, the signal processor 22 may include two types of signal processing circuits, i.e., a first signal processing circuit 221 and a second signal processing circuit 222. The first and second signal processing circuits 221 and 222 may share a digital signal of one SPAD 211. The first and second signal processing circuits 221 and 222 may correspond to a combination of two of the signal processing circuits described above. The number of types of signal processing circuits sharing the digital signal terminal of one SPAD 211 may be at least 2. For example, there may be three or four types of signal processing circuits. The SPAD 211 of each of all pixels 20 may be connected to multiple types of signal processing circuits, but the embodiment is not limited thereto. For example, a digital signal terminal connected to several SPADs 211 may be connected to a single signal processing circuit, and a digital signal terminal connected to other several SPADs 211 may be connected to and shared by multiple types of signal processing circuits.

As described above, according to the embodiment, the solid-state imaging device 100 may include multiple types of signal processing circuits, which share a digital signal output from a SPAD 211 and perform different operations from each other. Accordingly, because an output from one SPAD 211 may be distributed to a plurality of signal processing circuits, spatial resolution may be prevented from being reduced and various types of signal processing may be performed in parallel.

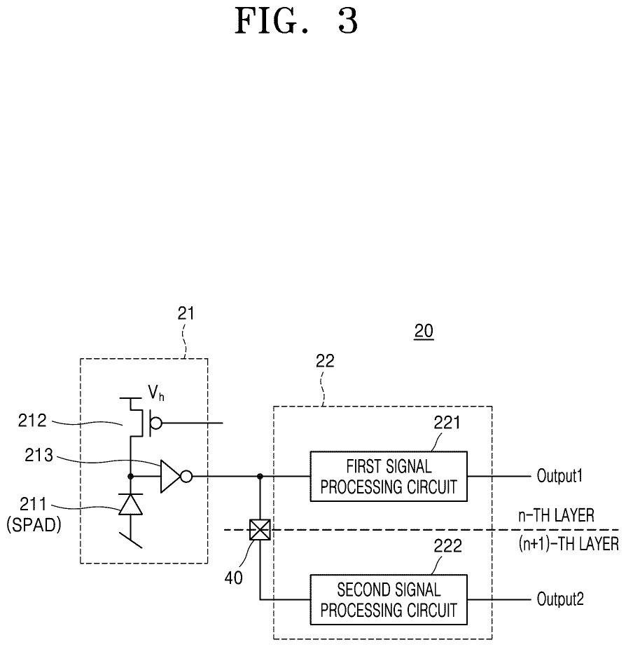

FIG. 3 is a block diagram illustrating multiple types of signal processing circuits respectively arranged in different wafers, according to an embodiment. Referring to FIG. 3, the solid-state imaging device 100 may have a stack structure. Unlike FIG. 2, the first signal processing circuit 221 and the second signal processing circuit 222 may be arranged in different wafers from each other. For example, the first signal processing circuit 221 may be arranged in an n-th layer, and the second signal processing circuit 222 may be arranged in an (n+1)-th layer that is one layer higher than the first signal processing circuit 221. The n-th layer may be the same as a layer, in which the photoelectric converter 21 including the SPAD 211 is arranged, or a nearby layer (e.g., an upper layer that is one layer higher the layer or a lower layer that is one layer lower than the layer). A digital signal terminal connected to the SPAD 211 in the n-th layer may be distributed to the second signal processing circuit 222 in the (n+1)-th layer by an interlayer connector 40. The interlayer connector 40 may include a Cu-to-Cu (CtoC) type connector that connects wafers to each other. By using the interlayer connector 40, circuit wiring may be concentrated in two dimensions so that high integration may be achieved. The example configuration of interlayer connection in FIG. 3 may be applied to various embodiments of this application. For example, the signal processing circuit corresponding to the still image counting circuit described above with reference to FIG. 2 may be arranged in the n-th layer, and the signal processing circuit corresponding to the moving image counting circuit described above with reference to FIG. 2 or the other signal processing circuits described above with reference to FIG. 2 may be arranged in the (n+1)-th layer in a wafer that is different from a wafer in which the n-th layer is arranged.

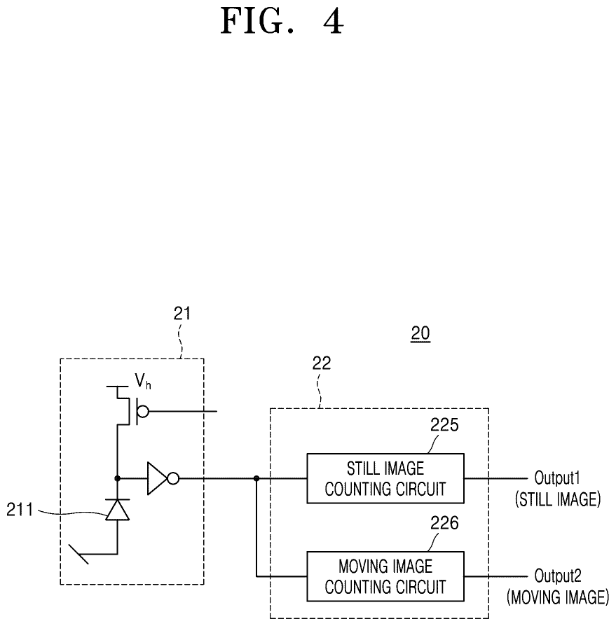

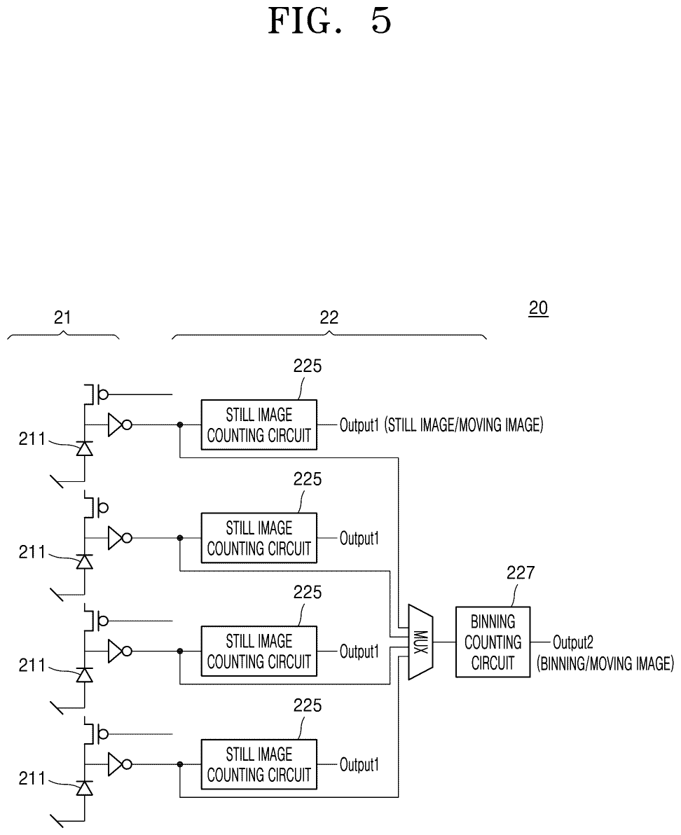

FIG. 4 is a block diagram illustrating a solid-state imaging device according to an embodiment. The embodiment may be an example of a combination of different types of counting circuits corresponding to signal processing circuits described above with reference to FIG. 2. For example, multiple types of signal processing circuits may be an example of a combination of a still image counting circuit and a moving image counting circuit. Reference numerals denoting some elements of the photoelectric converter 21 may be omitted from FIGS. 4 (and also FIG. 5 and below).

Referring to FIG. 4, a digital signal terminal connected to the SPAD 211 may be connected in parallel to a still image counting circuit 225 and a moving image counting circuit 226. The still image counting circuit 225 may correspond to an N-bit counter, and the moving image counting circuit 226 may correspond to an M-bit counter. For example, N and M may each be one of 8 and 12. N bits and M bits may be read out at different timings from each other. Still image data may be output via an output Output1 from the still image counting circuit 225 of each of the pixels 20, and moving image data may be output via an output Output2 from the moving image counting circuit 226.

As described above, in the solid-state imaging device of the embodiment, multiple types of signal processing circuits connected to the SPAD 211 may include at least a still image counting circuit generating a still image and a moving image counting circuit generating a moving image. Because the output of the SPAD 211 includes a digital pulse, the output from one SPAD 211 may be distributed to multiple signal processing circuits. Because there is no need to separately provide photoelectric conversion elements for respective signal processing circuits and there is no need to divide a light-receiving surface into areas for photoelectric conversion elements having different purposes, it may be possible to prevent a decrease in spatial resolution and simultaneously generate image data of different types or purposes, such as a still image and a moving image.

FIG. 5 is a block diagram illustrating a solid-state imaging device according to an embodiment. The embodiment may be an example of a combination of the signal processing circuit described above with reference to FIG. 2. For example, multiple types of signal processing circuits may include a still image counting circuit and a binning counting circuit. In other words, the embodiment may be an example of a combination of a signal processing circuit for still images and a signal processing circuit for binning.

Referring to FIG. 5, a digital signal terminal connected to the SPAD 211 may be connected in parallel to the still image counting circuit 225 and a binning counting circuit 227. The binning counting circuit 227 may be connected to digital signal terminals respectively connected to multiple SPADs 211 through a MUX. Here, the MUX may include a circuit that serializes signals input in parallel from multiple SPADs 211. The MUX may transmit multiple digital signals from respective digital signal terminals to the binning counting circuit 227 as a single output.

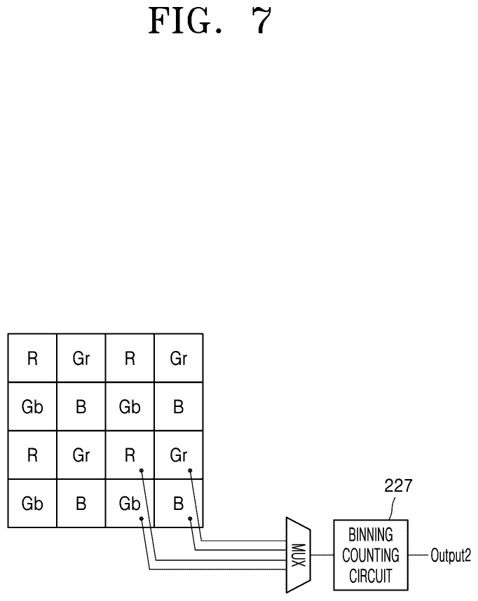

Referring to FIG. 5, digital signals from four SPADs 211 may be summed and output by the binning counting circuit 227. For example, a combination of the four SPADs 211 may be as shown in FIG. 6. Referring to FIG. 6, four adjacent pixels 20 (or photoelectric converters 21) of the same color filter in a bayer pattern may be binned by the binning counting circuit 227. Hereinafter, “adjacent pixels” may be referred to as adjacent pixels of the same color. For example, adjacent B and B or adjacent Gb and Gb in FIG. 6 may be referred to as adjacent pixels. For example, when color information is unnecessary in monochrome, the signals of adjacent pixels 20 may be binned by the binning counting circuit 227, as shown in FIG. 7.

As described above, in the solid-state imaging device of the embodiment, multiple types of signal processing circuits connected to a SPAD 211 may include a first signal processing circuit connected to one SPAD 211 and a second signal processing circuit connected to a plurality of SPADs 211. The second signal processing circuit may correspond to a binning counting circuit that counts the sum of the digital signals from the plurality of SPADs 211. Accordingly, an output from one SPAD 211 may be distributed to a plurality of signal processing circuits. Accordingly, image data of different types or different purposes, such as a high-resolution still image and a low-resolution but high-sensitivity still image or moving image, which is obtained through binning, may be simultaneously generated. For example, a moving image having a high resolution and a low frame rate (e.g. 30 fps) may be generated from the signal of an output Output1 in FIG. 5, and a moving image having a low resolution and a high frame rate (e.g., 240 fps) may be gencrated from the signal of an output Output2 resulting from 2×2 binning, wherein the moving images are generated in parallel. To generate two types of moving images in a comparative example, a moving image having a high resolution and a high frame rate (e.g., 240 fps) is first generated and then processed. However, in the embodiment, two types of moving images may be directly and simultaneously generated.

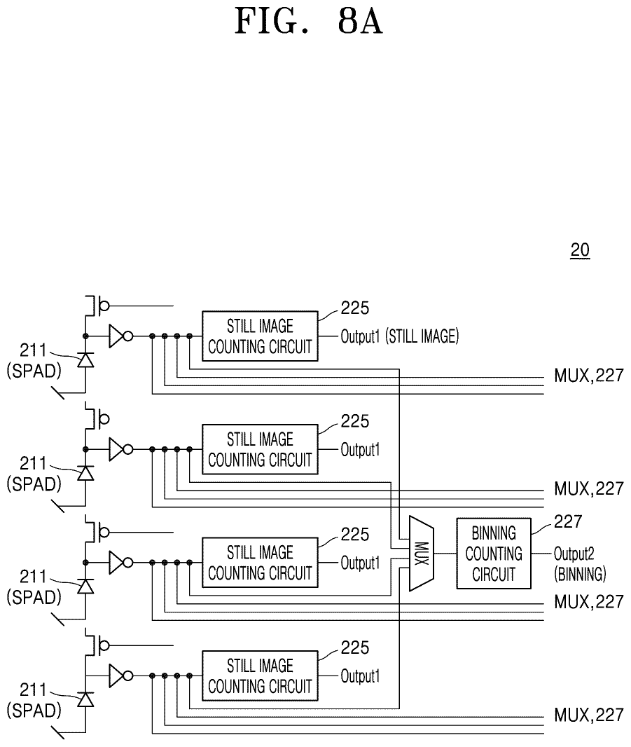

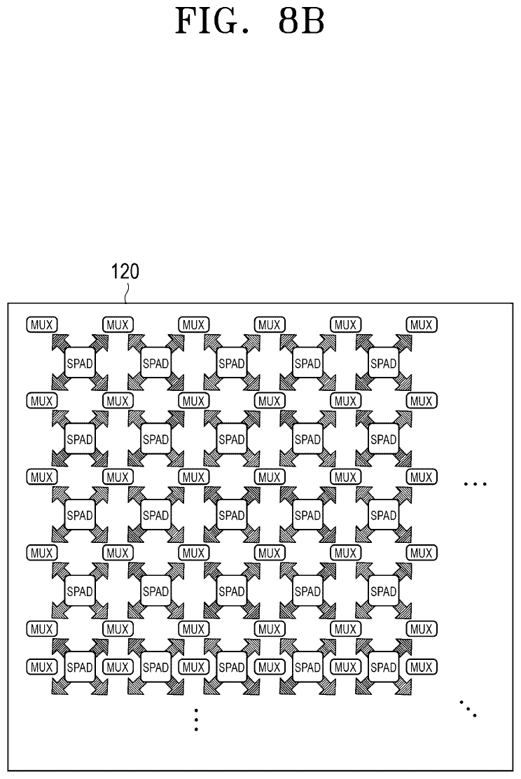

FIG. 8A is a block diagram illustrating a solid-state imaging device according to an embodiment. FIG. 8B is a block diagram illustrating a planar arrangement of FIG. 8A, according to an embodiment. Like the embodiment above, this embodiment may be an example of a combination of the signal processing circuits described above with reference to FIG. 2. For example, multiple types of signal processing circuits may include a still image counting circuit and a binning counting circuit.

Referring to FIGS. 8A and 8B, digital signals (denoted by arrows in FIG. 8B) from four SPADs 211 may be summed and output by the binning counting circuit 227. A digital signal from one SPAD 211 may be transmitted to one still image counting circuit 225 and four binning counting circuits 227. As shown in FIG. 8B, the number (i.e., four) of digital signals from the SPAD 211 collected in a binning counting circuit performing binning may be the same as the number (i.e., four) of binning counting circuits connected in parallel to one SPAD 211. Accordingly, the number of binning counting circuits may be the same as the number of SPADs 211, and the resolution of image data generated through binning may be the same as the resolution of image data generated from the output of a still image counting circuit for each SPAD 211.

A combination of four SPADs 211 connected to each of the binning counting circuits 227 may be the same as that in FIG. 6 and may include SPADs 211 of photoelectric converters 21 in which adjacent filters of the same color are respectively arranged. This embodiment may provide the same effect as the embodiment above. Because an output from one SPAD 211 may be distributed to a plurality of signal processing circuits in the embodiment, image data obtained through binning may have high sensitivity and high resolution. Although this example is given for still images, the same may be applied to moving images.

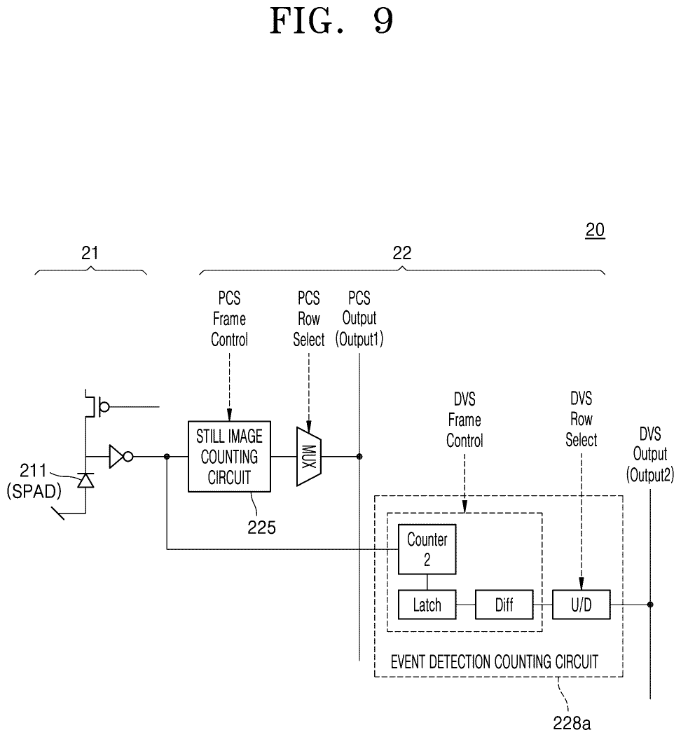

FIG. 9 is a block diagram illustrating a solid-state imaging device according to an embodiment. The embodiment may be an example of a combination of the signal processing circuits described above with reference to FIG. 2. For example, multiple types of signal processing circuits may include a still image counting circuit and an event detection counting circuit. In other words, the embodiment may be an example of a combination of a typical signal processing circuit for still images and a signal processing circuit for event detection.

Referring to FIG. 9, a digital signal terminal connected to the SPAD 211 may be connected in parallel to the still image counting circuit 225 and an event detection counting circuit 228a.

The event detection counting circuit 228a may be used as a dynamic vision sensor (DVS) and may detect a temporal change in incident light, i.e., an event caused by movement of an object, through a circuit configuration described below and output a detection signal (e.g., Output2). In the embodiment, a DVS frame rate may be controlled to be synchronized to an integer multiple higher than a photo counting sensor (PCS) frame rate. A PCS output (e.g., Output1) may be corrected based on an event detection signal at a high frame rate so that a high-frame rate image having low motion blur may be output.

The event detection counting circuit 228a may include a second counter Counter2, a latch, and a differen tial circuit Diff. The second counter Counter2 may generate a count value obtained by counting digital signals corresponding to respective photons incident to the SPAD 211 in a current frame. The latch may hold the count value of a previous frame. The differential circuit Diff may compare the count value of the previous frame, which is held by the latch, with the count value, which is obtained by the second counter Counter2 with respect to the current frame. At this time, it may be said that the differential circuit Diff obtains a difference value. When the count value of the current frame is greater than the count value of the previous frame and the difference value between the two count values is greater than a certain threshold value, an up/down (U/D) circuit U/D may activate an up signal. When the count value of the current frame is less than the count value of the previous frame and the difference value between the two count values is greater than the certain threshold value, an U/D circuit U/D may activate a down signal. The U/D circuit U/D may output an up signal or a down signal when a row is selected.

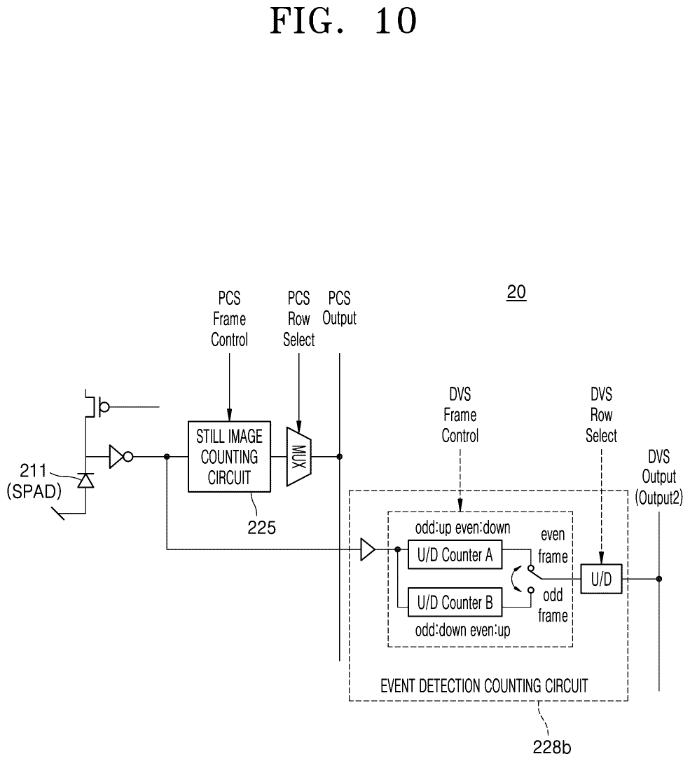

FIG. 10 is a block diagram illustrating a solid-state imaging device according to an embodiment. Although the configuration of an event detection counting circuit 228b is different from that of the event detection counting circuit 228a in FIG. 9, the event detection counting circuit 228b may have the same functions as the event detection counting circuit 228a, as described above.

Specifically, the event detection counting circuit 228b may include a U/D counter A and a U/D counter B. The U/D counter A may count up the number of photons from the SPAD 211 in an odd frame, count down the number of photons from the SPAD 211 in an even frame, and obtain difference information regarding the number of photons between the two frames. The U/D counter B may count up the number of photons from the SPAD 211 in an even frame, count down the number of photons from the SPAD 211 in an odd frame, and obtain difference information regarding the number of photons between the two frames. Due to this configuration, both difference information regarding the number of photons in the trend from an odd frame to a subsequent even frame and difference information regarding the number of photons in the trend form an even frame to a subsequent odd frame may be obtained. The U/D circuit U/D at the back of this configuration may activate an up signal or a down signal based on threshold value determination as in the event detection counting circuit 228a.

As described above, in the solid-state imaging device of the embodiment, multiple types of signal processing circuits connected to the SPAD 211 may include a still image counting circuit, which is connected to the SPAD 211 and counts digital signals, and an event detection counting circuit, which is connected to the SPAD 211 and detects a temporal signal change. Accordingly, because an output from one SPAD 211 may be distributed to a plurality of signal processing circuits, generation of a still image and DVS detection may be simultaneously performed. Accordingly, because there is no need to separately provide a SPAD 211 exclusively for DVS detection, the decrease in spatial resolution that occurs when the SPAD 211 exclusively for DVS detection is provided may be suppressed. Although this example is given for still images, the same may be applied to moving images.

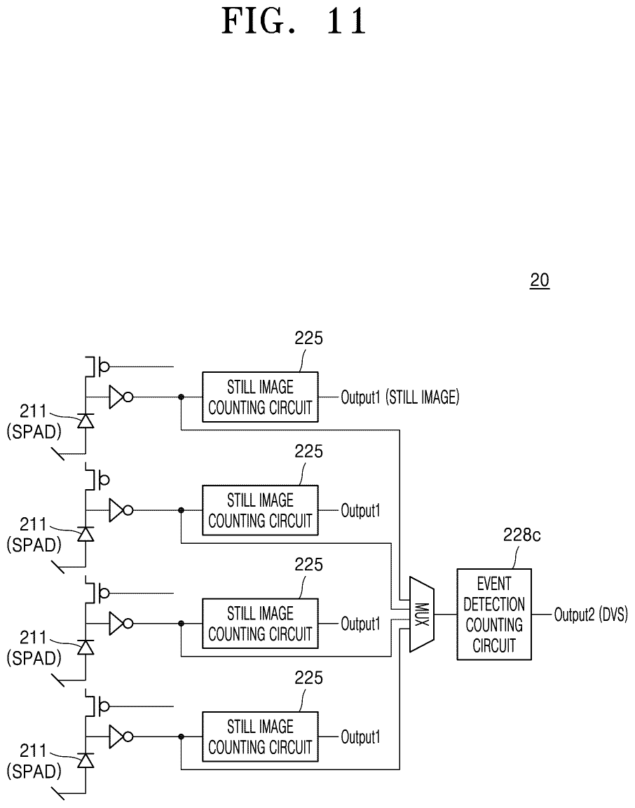

FIG. 11 is a block diagram illustrating a solid-state imaging device according to an embodiment. The embodiment may be an example of a combination of the signal processing circuits described above with reference to FIG. 2. For example, multiple types of signal processing circuits may include a still image counting circuit connected to one SPAD 211 and an event detection counting circuit, which is connected to a plurality of SPADs 211 and detects a temporal signal change in the sum of digital signals. In other words, the embodiment may be an example of a combination of a signal processing circuit for still images and a signal processing circuit for binning event detection.

Referring to FIG. 11, a digital signal terminal connected to the SPAD 211 may be connected in parallel to the still image counting circuit 225 and an event detection counting circuit 228c. Digital signals respectively from the plurality of SPADs 211 may be transmitted to the event detection counting circuit 228c through a MUX.

The event detection counting circuit 228c in FIG. 11 may include the same circuit configuration as the event detection counting circuit 228a in FIG. 9 or the event detection counting circuit 228b in FIG. 10 and may thus be used as a DVS and may detect a temporal change, i.e., an event, in incident light and output a detection signal (e.g., Output2). In this embodiment like the embodiment above, a DVS frame rate may be controlled to be synchronized to an integer multiple higher than a PCS frame rate. A PCS output (e.g., Output1) may be corrected based on an event detection signal at a high frame rate so that a high-frame rate image having low motion blur may be output.

As described above, the solid-state imaging device of the embodiment may include a still image counting circuit connected to only on SPAD 211 and a second signal processing circuit connected to a plurality of SPADs 211, wherein the second signal processing circuit may correspond to an event detection counting circuit 228 that adds the signals of the SPADs 211 and then detects a temporal change in the signals. In the present embodiment, the sensitivity may be increased by collecting the outputs of a plurality of SPADs 211 so that event detection may be possible even at a lower illumination or a faster signal change compared to the embodiment above. Although this example is given for still images, the same may be applied to moving images.

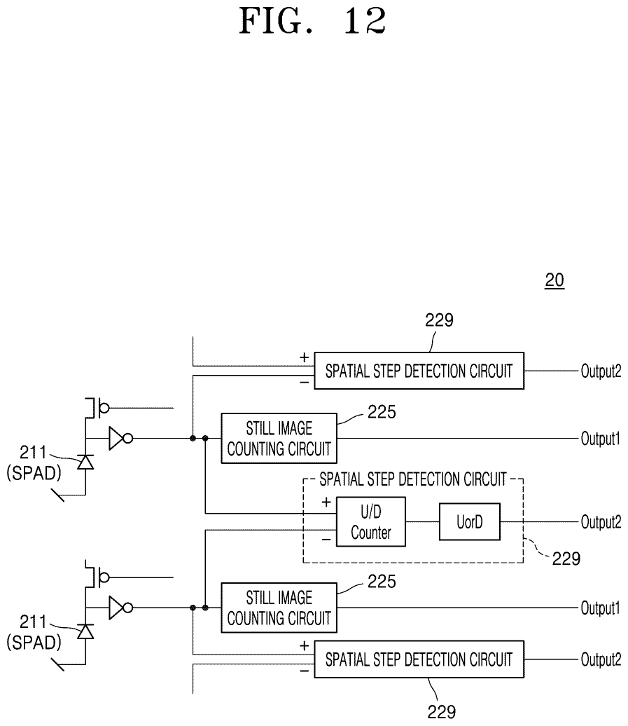

FIG. 12 is a block diagram illustrating a solid-state imaging device according to an embodiment. The embodiment may be an example of a combination of the signal processing circuits described above with reference to FIG. 2. For example, multiple types of signal processing circuits may include a still image counting circuit connected to one SPAD 211 and a spatial step counting circuit used to detect a step or an edge based on a contrast difference between two SPADs 211. In other words, the embodiment may be an example of a combination of a still image counting circuit (e.g., a typical signal processing circuit for still images) and a spatial step counting circuit (e.g., a signal processing circuit for spatial direction step detection).

Referring to FIG. 12, a digital signal terminal connected to the SPAD 211 may be connected in parallel to the still image counting circuit 225 and two spatial step counting circuits 229. Digital signals respectively from two SPADs 211 may be transmitted to one spatial step counting circuit 229. Two SPADs 211 may correspond to pixels (or photoelectric converters 21) adjacent to each other in the row direction or the column direction. Referring to FIG. 12, the spatial step counting circuit 229 may be connected to two pixels adjacent to each other in the column direction.

The spatial step counting circuit 229 in FIG. 12 may include a U/D counter and a U or D circuit UorD. The U/D counter may count up digital signals input to an up count input terminal (e.g., a positive terminal) with respect to a certain initial offset value and may count down the number of pulses input to a down count input terminal (e.g., a negative terminal). When a count value of the U/D counter is greater than a certain upper threshold value or less than a certain lower threshold value, the U or D circuit UorD may output a signal indicating that there is an edge (or a step) and a direction of the contrast. In FIG. 12, image data indicating the position of an edge may be generated with the same resolution as the resolution of image data formed by the still image counting circuit 225. The image data indicating the position of an edge may represent an edge in the row direction crossing the column direction in FIG. 12.

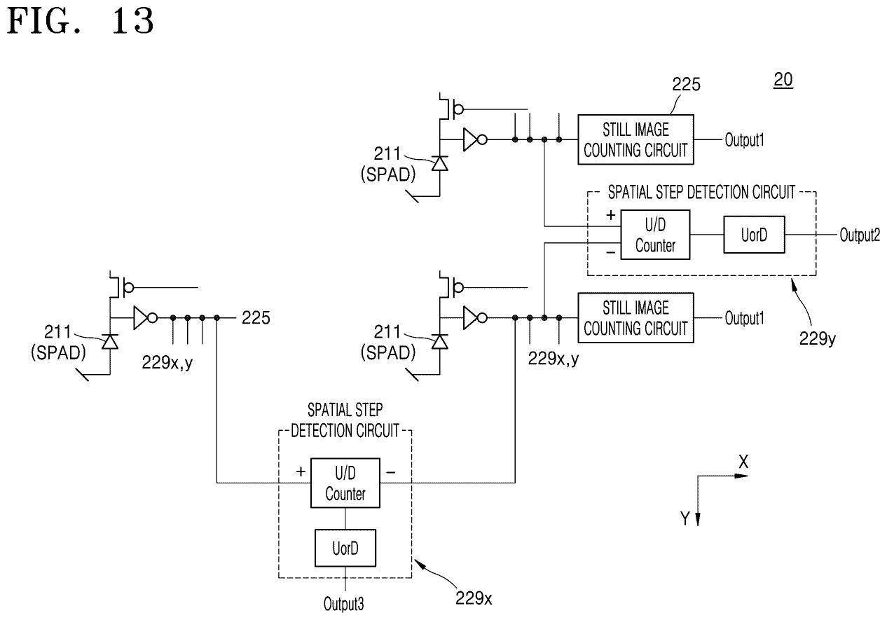

FIG. 13 is a block diagram illustrating a solid-state imaging device according to an embodiment. FIG. 12 illustrates an example in which the spatial step counting circuit 229 is connected to two pixels adjacent to each other in the column direction. Referring to FIG. 13, in addition to a spatial step counting circuit 229y connected to two pixels adjacent to each other in the column direction (the Y direction), a spatial step counting circuit 229x connected to two pixels adjacent to each other in the row direction (the X direction) may be further provided. Referring to FIG. 13, three pieces of image data, i.e., image data representing an edge in the row direction, image data representing an edge in the column direction, and typical image data, may be generated.

As described above, the solid-state imaging devices in the examples of the embodiment may include a still image counting circuit connected to only one SPAD 211 and a second signal processing circuit connected to a plurality of SPADs 211. The second signal processing circuit may correspond to a spatial step counting circuit that counts an output difference in digital signal between a plurality of SPADs 211 at different positions. Accordingly, because an output from one SPAD 211 may be distributed to a plurality of signal processing circuits, image data of different types or different purposes, such as image data of a typical still image and image data representing a step in the column direction and/or the row direction, may be simultaneously generated. Although this example is given for still images, the same may be applied to moving images.

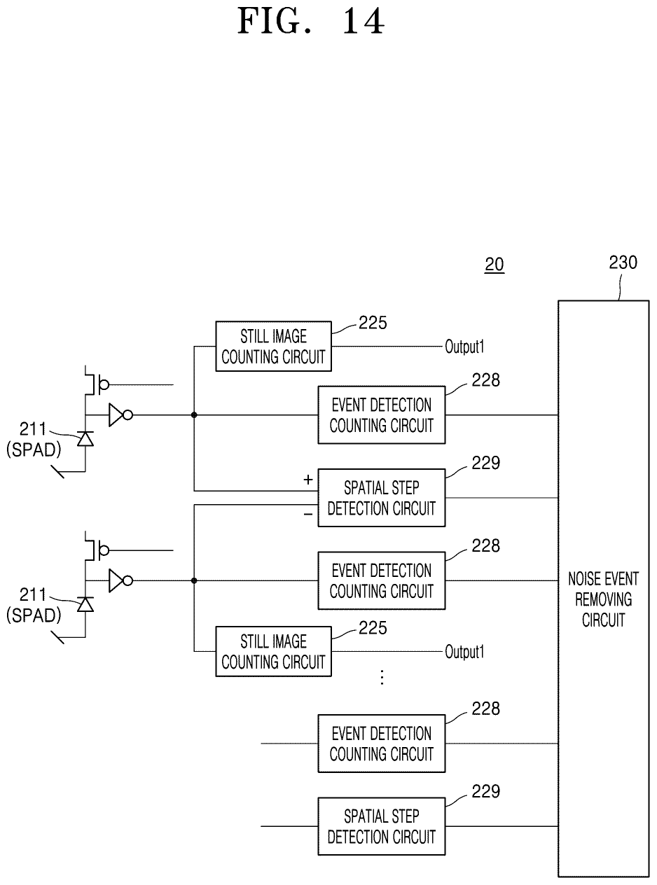

A solid-state imaging device according to the embodiment is described with reference to FIGS. 14 to 19. The embodiment relates to a solid-state imaging device that removes the influence of a flicker. Light from an artificial light, such as a fluorescent light or a light-emitting diode (LED) light, is powered by a commercial power supply. A flicker may refer to a phenomenon in which the luminance of the light changes due to the lighting method of the fluorescent light or fluctuation in power supply caused by the frequency of the commercial power supply. Even when there is no movement of an object and no temporal change in the quantity of incident light, a temporal change in the quantity of light may be erroneously detected because of the influence of a flicker.

FIG. 14 is a block diagram illustrating a solid-state imaging device according to an embodiment. The embodiment may be an example of a combination of the signal processing circuits described above with reference to FIG. 2. For example, multiple types of signal processing circuits may include a still image counting circuit connected to one SPAD 211, an event detection counting circuit, and a spatial step counting circuit used to detect a step or an edge based on a contrast difference between two SPADs 211. In other words, the embodiment may be an example of a combination of a typical signal processing circuit for still images, a signal processing circuit for event detection, and a signal processing circuit for spatial direction step detection.

Referring to FIG. 14, a digital signal terminal connected to the SPAD 211 may be connected in parallel to the still image counting circuit 225, the event detection counting circuit 228, and the spatial step counting circuits 229. The event detection counting circuit 228 may have the same configuration as the event detection counting circuit 228a in FIG. 9. A plurality of event detection counting circuits 228 and a plurality of spatial step counting circuits 229 may be connected to a noise event removing circuit 230. When the output of the noise event removing circuit 230 is enabled in a frame, an asynchronous exposure signal may be output to a corresponding pixel (or photoelectric converter 21) up to a subsequent frame or during a certain number of frames from the subsequent frame. During that time, exposure by the SPAD 211 (i.e., counting digital signals corresponding to incident photons) may be performed.

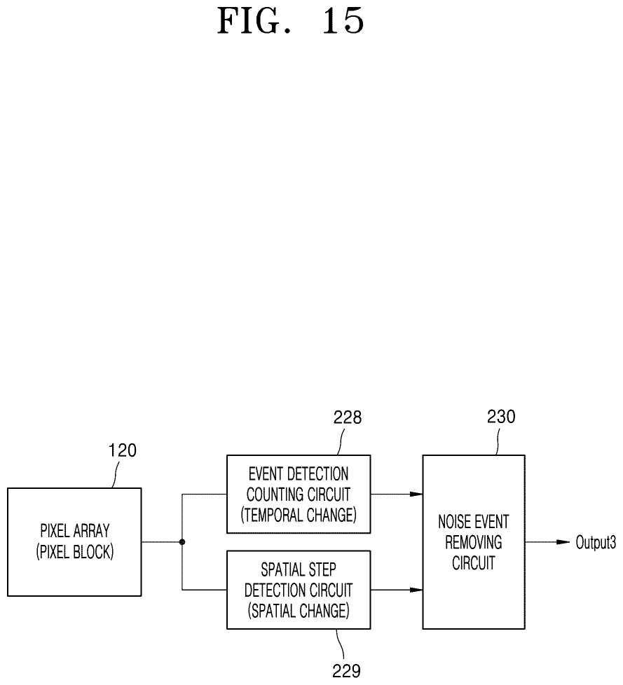

FIG. 15 is a block diagram illustrating the flow of data in a solid-state imaging device, according to an embodiment. FIG. 15 may illustrate the flow of data among some circuits. A digital signal from each of a plurality of pixels (or photoelectric converters 21) in a pixel block of the pixel array 120 may be transmitted to the corresponding event detection counting circuit 228 and the spatial step counting circuit 229, and output signals resulting from comparison and determination may be transmitted to the noise event removing circuit 230 further downstream. For example, the pixel block may include a block composed of 8×8 pixels or 4×4 pixels or a block composed of columns or rows. Hereinafter, a pixel block is described as being composed of one row of pixels in the X direction. A pixel block composed of a plurality of pixels may include one noise event removing circuit 230, a plurality of event detection counting circuits 228, and a plurality of spatial step counting circuits 229. The solid-state imaging device 100 according to the embodiment may include a combination of an event detection counting circuit 228 for event detection (i.e., a temporal change) and a spatial step counting circuit 229 detecting a step between adjacent pixels. Based on the outputs of these two types of comparison circuits, a flickering region may be determined, as described below, and a noise event caused by a flicker may be removed.

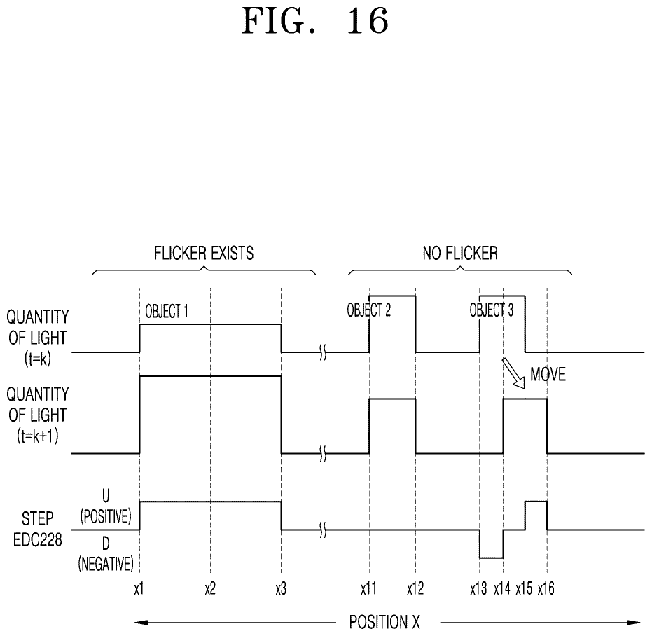

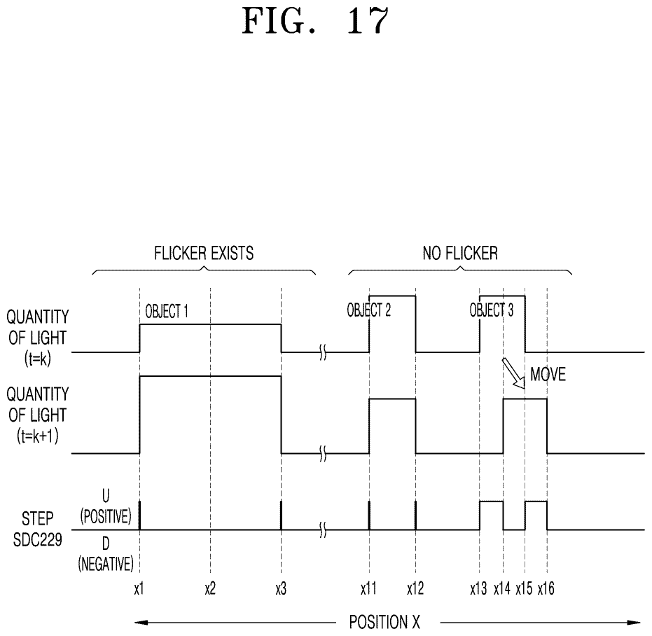

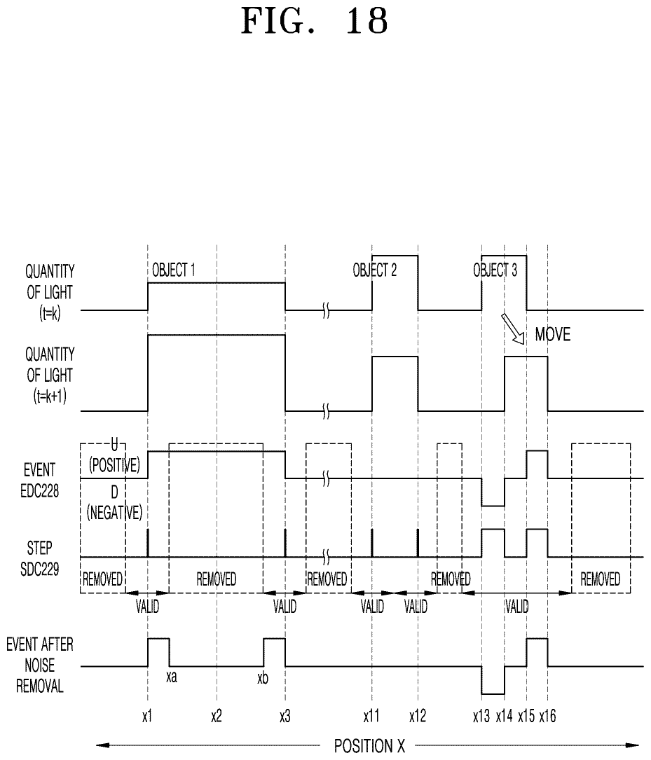

The influence of a flicker is described below with reference to FIGS. 16 and 17. Thereafter, the effects of the embodiment illustrated in FIGS. 14 and 15 are described with reference to FIG. 18.

FIG. 16 is a graph illustrating the influence of a flicker. An embodiment illustrated in FIG. 16 may correspond to the embodiment illustrated in FIG. 9, etc. FIG. 17 is a graph illustrating the influence of a flicker. An embodiment illustrated in FIG. 17 may correspond to the embodiment illustrated in FIG. 12, etc.

The following is common in FIGS. 16 to 18. The horizontal axis may indicate the position of a pixel in the X direction. FIGS. 16 to 18 show the quantity of light (or a count value) of a pixel 20 in each of a current frame (frame of t=k+1, hereinafter referred to as current frame) and a previous frame (frame of t=k, hereinafter referred to as previous frame) and an output of each comparison circuit in each of the current frame and the previous frame.

In the previous frame, objects 1, 2, and 3 are respectively in positions x1 to x3, positions x11 to x12, and positions x13 to x15, in which the quantity of light (or luminance) is higher than in the surroundings.

Among objects 1 to 3, objects 1 and 2 do not move in the X direction, and object 3 moves in the X direction (or to the right). According to the movement, in the current frame following the previous frame, the positions of objects 1 and 2 do not change, but object 3 moves to the right from the positions x13 to x15 to positions x14 to x16. It is shown that the luminance of object 1 is higher in the current frame than in the previous frame due to the influence of a flicker. Although the X direction is shown as the horizontal axis in FIGS. 16 to 18, it may also be applied to the Y direction or both the X and Y directions (see FIG. 13).

An example shown in FIG. 16 may include only the event detection counting circuit 228 between two types of signal processing circuits, e.g., an event detection counting circuit and a spatial step counting circuit. When there is a flicker, the event detection counting circuit 228 may detect an event even in a region of object 1 (in the positions x1 to x3) that has no movement. This event is an unintended even, hereinafter referred to as a noise event or noise. An original event caused by the movement of an object is detected in object 3 (in the positions x13 to x16). Because there is no influence of a flicker and no movement of an object, an event is not detected in object 2 (in the positions x11 to x12).

An example shown in FIG. 17 may include only the spatial step counting circuit 229 between two types of signal processing circuits, e.g., an event detection counting circuit and a spatial step counting circuit. The magnitude of a step may be changed even when there is a flicker in object 1. The step may be detected by the spatial step counting circuit 229, and the position of object 1 is not changed. In the range from the position x1 to the position x3 of object 1, in which there is no step, except for the positions x1 and x3 each having a step, a step may not be detected even when there is a change in luminance due to a flicker. Even in a range in which there is no flicker, a step is detected at each of the positions x11 and x12, and a step may be detected at one of the positions x13 to x14 and the positions x15 to x16.

The embodiment illustrated in FIG. 18 may include both two types of signal processing circuits, e.g., the event detection counting circuit 228 and the spatial step counting circuit 229. The noise event removing circuit 230 may set, as valid, pixels in a certain range in the X direction from a step detected by the spatial step counting circuit 229 and may set the other pixels to be removed. By masking a removal range from an event detected by the event detection counting circuit 228, among noise caused by a flicker, noise in a planar portion (from a position xa to a position xb) may be removed although noise at a step portion (defined as a dot or a line) may not be completely removed. Accordingly, the number of pixels influenced by a flicker may be reduced.

As described above, in the solid-state imaging device according to the embodiment, multiple types of signal processing circuits may include a still image counting circuit, which is connected to one SPAD 211 and counts digital signals, an event detection counting circuit, which is connected to one SPAD 211 and detects a temporal signal change, a spatial step counting circuit, which is connected to a plurality of SPADs 211 and detects a step, and the noise event removing circuit 230, which removes a noise event caused by a flicker in a light source, based on the output of the event detection counting circuit and the output of the spatial step counting circuit. Accordingly, because the decrease in spatial resolution may be prevented and an output from the SPAD 211 may be distributed to a plurality of signal processing circuits, the generation of a still image and DVS detection with a reduced influence of a flicker may be simultaneously performed.

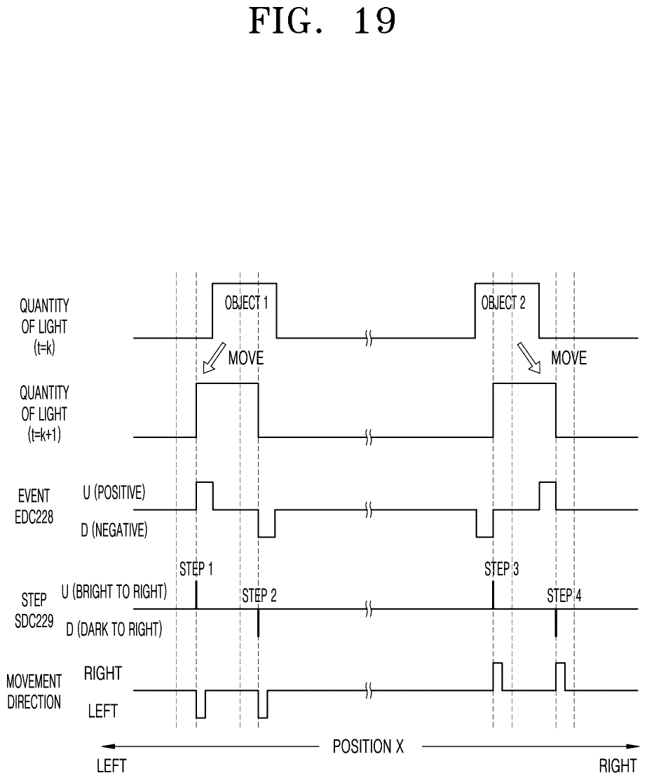

FIG. 19 is a block diagram illustrating effects of an embodiment. Referring to FIG. 19, the spatial step counting circuit 229 may represent a left or right contrast direction according to an up or down signal U or D. In the example illustrated in FIG. 19, the noise event removing circuit 230 may function as a movement direction detection circuit. A movement direction may be determined by combining the direction of an event detected by the event detection counting circuit 228 and the contrast direction of a step detected by the spatial step counting circuit 229.

Specifically, the movement direction of step 1 may be determined to be left when the direction of the detected event is up U and the contrast is bright to the right (i.e., the right side of step 1 is bright). The movement direction of step 2 may be determined to be left when the direction of the detected event is down D and the contrast is dark to the right (i.e., the right side of step 2 is dark).

The movement direction of step 3 may be determined to be right when the direction of the detected event is down D and the contrast is bright to the right (i.e., the right side of step 3 is bright). The movement direction of step 4 may be determined to be right when the direction of the detected event is up U and the contrast is dark to the right (i.e., the right side of step 4 is dark).

As described above, in the solid-state imaging device according to the embodiment, the noise event removing circuit 230, which removes a noise event, may function as a movement direction detection circuit. Accordingly, because an output from one SPAD 211 may be distributed to a plurality of signal processing circuit, the generation of a still image and DVS detection with a reduced influence of a flicker may be simultaneously performed, and information on the direction of a movement of an object may also be obtained. Although this example is given for still images, the same may be applied to moving images.

The embodiment provides the following effects by using the following configuration.

In the solid-state imaging device according to the present embodiment, multiple types of signal processing circuits may share a digital signal output from one SPAD 211 according to the number of photons incident to the SPAD 211. Accordingly, because an output from one SPAD 211 may be distributed to a plurality of signal processing circuits, various types of signal processing may be performed simultaneously.

In the solid-state imaging device according to the present embodiment, multiple types of signal processing circuits may include at least a still image counting circuit generating a still image and a moving image counting circuit generating a moving image. Accordingly, the decrease in spatial resolution may be prevented, and image data of different types or different purposes, such as a still image and a moving image, may be simultaneously generated.

In the solid-state imaging device according to the present embodiment, multiple types of signal processing circuits may include at least an event detection counting circuit detecting a temporal signal change. Accordingly, because an output from one SPAD 211 may be distributed to a plurality of signal processing circuits, the generation of a still image and DVS detection may be simultaneously performed. Accordingly, because there is no need to separately provide a SPAD 211 exclusively for DVS detection, the decrease in spatial resolution that occurs when the SPAD 211 exclusively for DVS detection is provided may be suppressed.

In the solid-state imaging device according to the present embodiment, multiple types of signal processing circuits connected to a SPAD 211 may include at least a first signal processing circuit connected to only one SPAD 211 and a second signal processing circuit connected to a plurality of SPADs 211. In particular, the second signal processing circuit may correspond to a binning counting circuit that counts the sum of the digital signals from the SPADs 211. Accordingly, the decrease in spatial resolution may be prevented, and image data of different types or different purposes, such as a typical high-resolution still image and a low-resolution but high-sensitivity still image or moving image, which is obtained through binning, may be simultaneously gencrated.

In the solid-state imaging device according to the present embodiment, multiple types of signal processing circuits connected to a SPAD 211 may include at least a first signal processing circuit connected to only one SPAD 211 and a second signal processing circuit connected to a plurality of SPADs 211. In particular, the second signal processing circuit may correspond to an event detection counting circuit that detects a temporal signal change in the sum of digital signals respectively from a plurality of SPADs 211. Accordingly, because an output from one SPAD 211 may be distributed to a plurality of signal processing circuits, the generation of a still image and DVS detection may be simultaneously performed. Accordingly, because there is no need to separately provide a SPAD 211 exclusively for DVS detection, the decrease in spatial resolution that occurs when the SPAD 211 exclusively for DVS detection is provided may be suppressed.

In the solid-state imaging device according to the present embodiment, multiple types of signal processing circuits connected to a SPAD 211 may include at least a first signal processing circuit connected to only one SPAD 211 and a second signal processing circuit connected to a plurality of SPADs 211. In particular, the second signal processing circuit may correspond to a spatial step counting circuit that counts an output difference in digital signal between a plurality of SPADs 211 at different positions. Accordingly, the decrease in spatial resolution may be prevented, and image data of different types or different purposes, such as image data of a typical still image and image data representing a step in the column direction and/or the row direction, may be simultaneously generated.

In the solid-state imaging device according to the present embodiment, multiple types of signal processing circuits connected to a SPAD 211 may include a counting circuit, which is connected to only one SPAD 211, an event detection counting circuit, which is connected to only one SPAD 211 and detects a temporal signal change, a spatial step counting circuit, which detects an output difference in digital signal between a plurality of SPADs 211 at different positions, and a noise event removing circuit, which removes a noise event caused by a flicker in a light source, based on the output of the event detection counting circuit and the output of the spatial step counting circuit. Accordingly, because an output from the SPAD 211 may be distributed to a plurality of signal processing circuits, the decrease in spatial resolution may be prevented, and the generation of a still image and DVS detection with a reduced influence of a flicker may be simultaneously performed.

The solid-state imaging device according to the present embodiment may have a multi-layer structure. Among multiple types of signal processing circuits, at least two types of signal processing circuits may be arranged in different wafers from each other, and a digital signal from one SPAD 211 may be distributed by an inter-wafer connection wiring. Accordingly, circuit wiring may be concentrated in two dimensions so that high integration may be achieved.

The main configurations of the solid-state imaging devices described above have been described in the embodiments. The embodiments are not limited to the configurations described above, and various modifications may be made in the embodiment within the scope of the following claims. In addition, configurations including general solid-state imaging devices are not excluded.

As described herein, any devices, systems, modules, portions, units, controllers, circuits, and/or portions thereof according to any of the example embodiments, and/or any portions thereof (including, without limitation, signal processing circuit, still/moving image counting circuit, event detection counting circuit, and spatial step counting circuit, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While the inventive concept has been particularly shown and described with reference to embodiments thereof, it will be understood that various changes in form and details may be made therein without departing from the spirit and scope of the following claims.

What is claimed is:

1. A solid-state imaging device comprising:
a plurality of pixels respectively including single-photon avalanche diodes (SPADs); and
at least two signal processing circuits performing different operations from each other,
wherein the at least two signal processing circuits are configured to receive a digital signal output from each of the SPADs.

2. The solid-state imaging device of claim 1, wherein
the at least two signal processing circuits comprise a still image counting circuit configured to generate a still image and a moving image counting circuit configured to generate a moving image.

3. The solid-state imaging device of claim 1, wherein the at least two signal processing circuits comprise an event detection counting circuit configured to detect a temporal signal change.

4. The solid-state imaging device of claim 3, wherein the event detection counting circuit comprises:
a counter configured to receive the digital signals respectively corresponding to a plurality of frames including a first frame and a second frame that precedes the first frame and generate a count value by counting the digital signals;
a latch configure to hold a count value corresponding to the second frame while the counter is generating a count value corresponding to the first frame;
a differential circuit configured to compare the count value corresponding to the first frame with the count value corresponding to the second frame and generate a comparison result value; and
an up/down circuit configured to generate a signal based on the comparison result value from the differential circuit.

5. The solid-state imaging device of claim 3, wherein the event detection counting circuit configured to receive the digital signal corresponding to each of a plurality of frames and comprises:
a first up/down counter configured to count up a number of photons in an odd frame among the plurality of frames, count down a number of photons in an even frame among the plurality of frames, and generate first differential information corresponding to a difference in the number of photons between consecutive frames;
a second up/down counter configured to count down a number of photons in the odd frame among the plurality of frames, count up a number of photons in the even frame among the plurality of frames, and generate second differential information corresponding to a difference in the number of photons between consecutive frames; and
an up/down circuit configured to generate a signal based on the first differential information and the second differential information.

6. The solid-state imaging device of claim 1, wherein
the at least two signal processing circuits comprise a first signal processing circuit connected to only one SPAD among the SPADs and a second signal processing circuit connected to a plurality of SPADs among the SPADs.

7. The solid-state imaging device of claim 6, wherein
the second signal processing circuit comprises a binning counting circuit configured to count a sum of the digital signals respectively output from at least two SPADs among the SPADs.

8. The solid-state imaging device of claim 6, wherein
the second signal processing circuit comprises an event detection counting circuit configured to detect a temporal change in a sum of the digital signals respectively output from at least two SPADs among the SPADs.

9. The solid-state imaging device of claim 6, wherein
the first signal processing circuit comprises a counting circuit connected to only one SPAD and an event detection counting circuit connected to the only one SPAD and configured to detect a temporal signal change, and
the second signal processing circuit comprises a spatial step counting circuit configured to detect an output difference in the digital signal between the SPADs at different positions.

10. The solid-state imaging device of claim 6, wherein
the second signal processing circuit comprises a spatial step counting circuit configured to count an output difference in the digital signal between at least two SPADs among the SPADs at different positions.

11. The solid-state imaging device of claim 10, wherein
the spatial step counting circuit is further configured to count the output difference in the digital signal between the at least two SPADs adjacent to each other in a row direction or a column direction among the SPADs.

12. The solid-state imaging device of claim 10, wherein
the spatial step counting circuit comprises a comparison circuit configured to count the output difference in the digital signal between the at least two SPADs among the SPADs, the at least two SPADs being of a same color and adjacent to each other.

13. The solid-state imaging device of claim 1, wherein the at least two signal processing circuits comprise:
a counting circuit connected to only one SPAD among the SPADs;
an event detection counting circuit connected to the only one SPAD among the SPADs and configured to detect a temporal signal change; and
a spatial step counting circuit configured to detect an output difference in the digital signal between a plurality of SPADs at different positions,
wherein the solid-state imaging device further comprises a noise event removing circuit connected to the event detection counting circuit and the spatial step counting circuit and configured to remove a noise event caused by a flicker in a light source, based on an output of the event detection counting circuit and an output of the spatial step counting circuit.

14. The solid-state imaging device of claim 1, wherein
the solid-state imaging device has a stack structure,
at least two types of signal processing circuits among the at least two signal processing circuits are respectively arranged in different layers, and
the solid-state imaging device further comprises an inter-layer connection wiring configured to distribute the digital signal from one of the SPADs.

15. A pixel array comprising:
a plurality of photoelectric converters; and
a plurality of signal processing circuits,
wherein each of the plurality of photoelectric converters comprises a single-photon avalanche diode (SPAD), and
the plurality of signal processing circuits comprise:
a first signal processing circuit configured to receive a first digital signal output from a SPAD included in a first photoelectric converter among the plurality of photoelectric converters; and
a second signal processing circuit configured to receive the first digital signal with the first signal processing circuit and perform a different operation than the first signal processing circuit.

16. The pixel array of claim 15, wherein
the first signal processing circuit comprises a still image counting circuit configured to generate a still image based on the first digital signal, and
the second signal processing circuit includes a moving image counting circuit configured to generate a moving image based on the first digital signal.

17. The pixel array of claim 15, wherein
the first signal processing circuit comprises at least one of a still image counting circuit configured to generate a still image based on the first digital signal and a moving image counting circuit configured to generate a moving image based on the first digital signal, and
the second signal processing circuit comprises a binning counting circuit configured to count a sum of digital signals respectively output from SPADs respectively included in at least two of the plurality of photoelectric converters.

18. The pixel array of claim 15, wherein
the first signal processing circuit comprises at least one of a still image counting circuit configured to generate a still image based on the first digital signal and a moving image counting circuit configured to generate a moving image based on the first digital signal, and
the second signal processing circuit comprises an event detection counting circuit configured to detect a temporal signal change based on the first digital signal.

19. The pixel array of claim 15, wherein
the first signal processing circuit comprises at least one of a still image counting circuit configured to generate a still image based on the first digital signal and a moving image counting circuit configured to generate a moving image based on the first digital signal, and
the second signal processing circuit comprises a spatial step counting circuit configured to count an output difference between digital signals respectively output from SPADs respectively included in at least two photoelectric converters at different positions among the plurality of photoelectric converters.

20. A solid-state imaging device comprising:
a pixel array including a plurality of pixels;
a vertical scanning unit configured to select a pixel corresponding to a row based on a synchronous signal among the plurality of pixels and control the selected pixel to output a signal;
a horizontal scanning unit configured to select a pixel corresponding to a column based on the synchronous signal among the plurality of pixels and control the selected pixel to output a signal; and
a signal output unit configured to receive a signal from the pixel array and output image data.
wherein each of the plurality of pixels includes:
a single-photon avalanche diode (SPAD); and
at least two signal processing circuits configured to receive a digital signal output from the SPAD and perform different operations from each other.
